(19) United States
(12) Patent Application Publication
(10) Pub. No.: US 2026/0175751 A1
(43) Pub. Date: Jun. 25, 2026

(54) RECLINING DEVICE AND VEHICLE SEAT

(71) Applicants: NHK SPRING CO., LTD., Yokohama-shi (JP); SUBARU CORPORATION, Tokyo (JP)

(72) Inventors: Hiroshi YAGAME, Yokohama-shi (JP); Yuhei TSUKUTA, Yokohama-shi (JP); Masaya SHODA, Yokohama-shi (JP); Noriyuki FUKUCHI, Yokohama-shi (JP); Fumito KITANAKA, Tokyo (JP); Masato FUKUSHIMA, Tokyo (JP); Ayaka KASHIWAGI, Tokyo (JP)

(21) Appl. No.: 19/423,715

(22) Filed: Dec. 17, 2025

(30) Foreign Application Priority Data
Dec. 20, 2024 (JP) 2024-225726

(51) Int. Cl. B60N 2/433; B60N 2/22; B60N 2/42

(52) U.S. Cl. CPC B60N 2/433; B60N 2/22; B60N 2/4235

(57) ABSTRACT

In a reclining device, a lock mechanism locks tilting of a seat back. A knob is connected to a shaft and a connecting bracket, and in a case in which the knob is operated, the shaft and the connecting bracket are rotated, and a lock mechanism unlocks tilting of the seat back. At a time of a side collision of a vehicle, the knob is disconnected from the shaft and the connecting bracket. Therefore, even in a case in which the knob is operated by an impact load, the rotation of the shaft and the connecting bracket can be suppressed, and the unlocking of the tilting of the seat back can be suppressed.

### CROSS-REFERENCE TO RELATED APPLICATION

This application is based on and claims priority under 35 USC 119 from Japanese Patent Application No. 2024-225726 filed on Dec. 20, 2024, the disclosure of which is incorporated by reference herein.

### BACKGROUND

### Technical Field

The present invention relates to a reclining device in which a lock mechanism locks tilting of a seat back, and a vehicle seat provided with the reclining device.

### Related Art

In a seat described in Japanese Patent Application Laid-Open (JP-A) No. 2000-108738, tilting of a seat back is locked, and a reclining lever is operated to unlock the tilting of the seat back.

In this seat, at the time of side collision of a vehicle, the operation of the reclining lever due to input of an impact load to the reclining lever is suppressed by a bracket for preventing upward shift of the lever, and unlocking of the tilting of the seat back is suppressed.

### SUMMARY

In view of the above fact, an object of the invention is to provide a reclining device and a vehicle seat which can suppress unlocking of tilting of a seat back at the time of side collision of a vehicle.

A reclining device of a first aspect of the invention includes: a lock mechanism locking tilting of a seat back in a vehicle seat; a connecting member provided at the lock mechanism, the connecting member being rotated so that the lock mechanism unlocks tilting of the seat back; and an operation member connected to the connecting member, the operation member being operated to rotate the connecting member and being disconnected from the connecting member by receiving an impact load at a time of a side collision of a vehicle.

In the reclining device of the first aspect of the invention, the lock mechanism locks tilting of the seat back in the vehicle seat. The operation member is connected to the connecting member of the lock mechanism, and the operation member is operated to rotate the connecting member, so that the lock mechanism unlocks tilting of the seat back.

At the time of a side collision of the vehicle, an impact load is input to the operation member, and the operation member is disconnected from the connecting member. Therefore, even in a case in which the operation member is operated by an impact load, the rotation of the connecting member can be suppressed, and the unlocking of the tilting of the seat back can be suppressed.

A reclining device of a second aspect of the invention in the reclining device of the first aspect of the invention includes a covering member covering the operation member and disconnecting the operation member from the connecting member by receiving an impact load at the time of a side collision of the vehicle to press the operation member.

In the reclining device of the second aspect of the invention, the operation member is covered with the covering member, and the operation member is disconnected from the connecting member by the covering member receiving an impact load and pressing the operation member at the time of a side collision of the vehicle. Therefore, the operation member can be disconnected from the connecting member.

In a reclining device of a third aspect of the invention in the reclining device of the second aspect of the invention, the covering member is disposed outside an outer periphery of the operation member.

In the reclining device of the third aspect of the invention, the covering member is disposed outside an outer periphery of the operation member. Therefore, an impact load can be input to the covering member before the operation member.

In a reclining device of a fourth aspect of the invention in the reclining device of any one of the first to third aspects of the invention, the operation member is broken by an impact load to be disconnected from the connecting member.

In the reclining device of the fourth aspect of the invention, the operation member is broken by an impact load to be disconnected from the connecting member. Therefore, the operation member can be disconnected from the connecting member.

A reclining device of a fifth aspect of the invention in the reclining device of the fourth aspect of the invention includes a fragile portion provided at the operation member and serving as a starting point of breakage of the operation member.

In the reclining device of the fifth aspect of the invention, the fragile portion of the operation member serves as a starting point of breakage of the operation member. Therefore, the operation member can be appropriately broken.

A reclining device of a sixth aspect of the invention in the reclining device of the fourth or fifth aspect of the invention includes a plurality of connecting portions provided at the operation member, each of the connecting portions being connected to the connecting member, and each of the connecting portions being disconnected from the connecting member due to the operation member being broken.

In the reclining device of the sixth aspect of the invention, each of the plurality of connecting portions of the operation member is connected to the connecting member, and each of the plurality of connecting portions is disconnected from the connecting member by the operation member being broken. Therefore, each of the plurality of connecting portions is connected to the connecting member, so that the connecting strength between the operation member and the connecting member can be increased.

In a reclining device of a seventh aspect of the invention in the reclining device of any one of the first to sixth aspects of the invention, the operation member is operated by a predetermined amount to cause the lock mechanism to unlock tilting of the seat back, and the operation member is operated by the predetermined amount or more to be connected to the connecting member after the operation member has been disconnected from the connecting member.

In the reclining device of the seventh aspect of the invention, the operation member is operated by the predetermined amount, and the lock mechanism unlocks tilting of the seat back.

After the operation member has been disconnected from the connecting member, the operation member is operated by the predetermined amount or more to be connected to the connecting member. Therefore, the operation member is further operated, so that the lock mechanism can unlock tilting of the seat back.

A reclining device of an eighth aspect of the invention in the reclining device of the seventh aspect of the invention includes an allowance portion provided at the operation member, the operation member being allowed to be operated by the predetermined amount or more by the allowance portion so that the operation member is connected to the connecting member after the operation member has been disconnected from the connecting member.

In the reclining device of the eighth aspect of the invention, after the operation member has been disconnected from the connecting member, the operation member is allowed to be operated by a predetermined amount or more by the allowance portion of the operation member and is connected to the connecting member. Therefore, the operation member can be connected to the connecting member after the predetermined amount or more of operation.

A vehicle seat of a ninth aspect of the invention includes: a seat cushion; a seat back; and the reclining device of any one of the first to eighth aspects of the invention provided between the seat cushion and the seat back.

In the vehicle seat of the ninth aspect of the invention, the reclining device of any one of the first to eighth aspects of the invention is provided between the seat cushion and the seat back. Therefore, the same effects as those of any one of the first to eighth aspects of the invention can be obtained.

### BRIEF DESCRIPTION OF THE DRAWINGS

Exemplary embodiments of the present invention will be described in detail based on the following figures, wherein:

FIG. 1 is an exploded perspective view illustrating a vehicle seat according to a first embodiment of the invention as viewed from a diagonally front left side;

FIG. 2A is a side view illustrating a normal state of the vehicle seat according to the first embodiment of the invention as viewed from a left side;

FIG. 2B is a side view illustrating a first stage in which a knob is operated to rotate after side collision of a vehicle in the vehicle seat according to the first embodiment of the invention as viewed from a left side;

FIG. 2C is a side view illustrating a second stage in which a knob is operated to rotate after the side collision of the vehicle in the vehicle seat according to the first embodiment of the invention as viewed from a left side;

FIG. 3 is a cross-sectional view (a cross-sectional view taken along line 3-3 in FIG. 2A) of the vehicle seat according to the first embodiment of the invention as viewed from a lower side;

FIG. 4A is a side view illustrating a first connecting portion of the knob in the vehicle seat according to the first embodiment of the invention as viewed from a left side;

FIG. 4B is a side view illustrating a second connecting portion of the knob and the like in the vehicle seat according to the first embodiment of the invention as viewed from a left side;

FIG. 4C is a perspective view illustrating a second connecting portion of the knob and the like in the vehicle seat according to the first embodiment of the invention as viewed from a diagonally front right side;

FIG. 5 is an exploded perspective view illustrating a vehicle seat according to a second embodiment of the invention as viewed from a diagonally front left side;

FIG. 6 is a side view illustrating the vehicle seat according to the second embodiment of the invention as viewed from a left side;

FIG. 7 is a cross-sectional view (a cross-sectional view taken along line 7-7 in FIG. 6) of the vehicle seat according to the second embodiment of the invention as viewed from a front side;

FIG. 8A is a perspective view illustrating the first connecting portion of the knob and the like of the vehicle seat according to the second embodiment of the invention as viewed from a diagonally front left side; and

FIG. 8B is a perspective view illustrating the first connecting portion of the knob and the like of the vehicle seat according to the second embodiment of the invention as viewed from a diagonally front right side.

### DETAILED DESCRIPTION

### First Embodiment

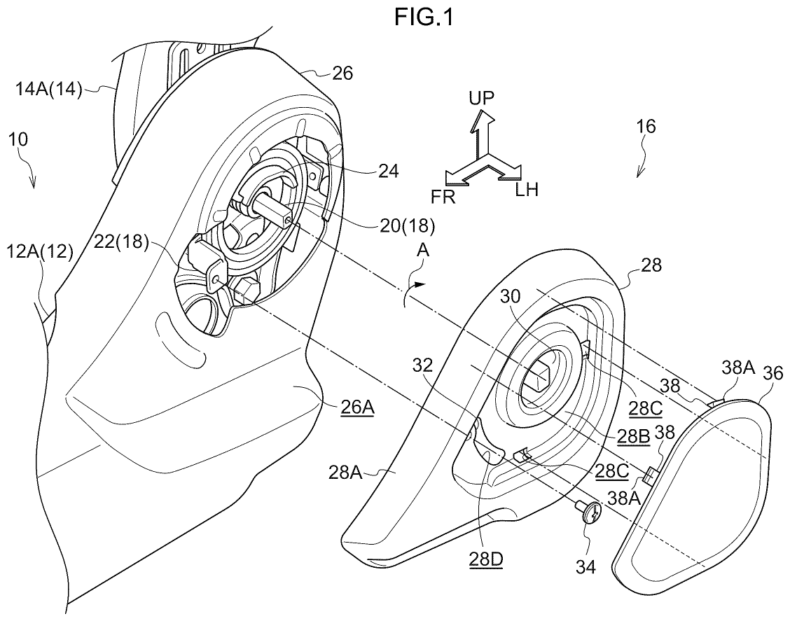

FIG. 1 is an exploded perspective view illustrating a vehicle seat 10 according to a first embodiment of the invention as viewed from a diagonally front left side. In the drawings, the front side of the vehicle seat 10 is indicated by an arrow FR, the left side (outside in a vehicle width direction) of the vehicle seat 10 is indicated by an arrow LH, and the upper side of the vehicle seat 10 is indicated by an arrow UP.

The vehicle seat 10 according to this embodiment is provided on the front side and the left side of a vehicle interior of a vehicle (automobile), and a B-pillar of the vehicle is disposed near the left side of a rear end portion of the vehicle seat 10. A seat cushion 12 is provided below the vehicle seat 10, and an occupant of the vehicle is seated on the seat cushion 12. A seat back 14 is provided on the upper side of a rear end portion of the seat cushion 12, and the seat back 14 supports the back of the occupant.

As illustrated in FIG. 1, a reclining device 16 is provided between a cushion hinge 12A of the seat cushion 12 and a back hinge 14A of the seat back 14.

A lock mechanism 18 is provided in the reclining device 16, and the lock mechanism 18 locks tilting of the seat back 14 (back hinge 14A). The lock mechanism 18 is provided with a shaft 20 made of a metal as a first connected portion constituting the connecting member, and the shaft 20 extends leftward and has a portion, which is formed in a substantially rectangular columnar shape, other than a proximal end portion (right end portion). The shaft 20 is made rotatable by a predetermined angle (predetermined amount) in a release direction A from an initial position, and the shaft 20 is made non-rotatable by exceeding a predetermined angle in the release direction A from the initial position.

A proximal end portion of a connecting bracket 22 having an elongated plate shape and made of a metal as a second connected portion constituting a connecting member is fixed to the shaft 20, and the connecting bracket 22 is rotatable integrally with the shaft 20. The distal end portion of the connecting bracket 22 is disposed on the front side of the shaft 20, and the vicinity of the distal end portion of the connecting bracket 22 is disposed perpendicular to the front-rear direction (the rotational radial direction of the shaft 20). The distal end portion of the connecting bracket 22 is disposed perpendicular to the right-left direction, and the distal end portion of the connecting bracket 22 has a substantially rectangular plate shape.

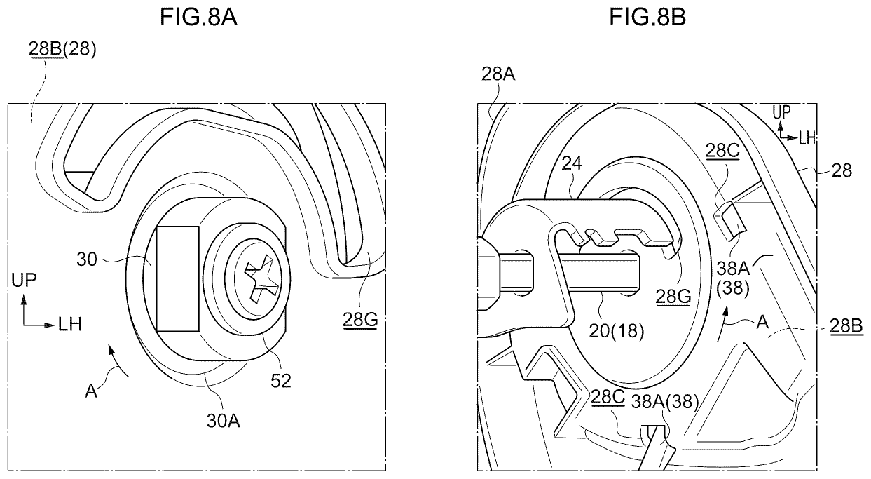

A bracket 24 (spring holding bracket, see FIG. 8B) having an L-shaped cross section plate shape and made of a metal is fixed around the shaft 20. A right wall of the bracket 24 is disposed perpendicular to a right-left direction, and the shaft 20 is rotatably passed through the right wall of the bracket 24. An upper wall of the bracket 24 protrudes leftward, and the upper wall of the bracket 24 is curved in a convex shape upward in a front-rear direction.

A cover 26 made of a resin as an arrangement member is provided on the left side of the lock mechanism 18, and the cover 26 covers a portion from a rear portion of the seat cushion 12 to a lower end portion of the seat back 14 from the left side. An arrangement recess 26A having a substantially trapezoidal shape in front view is formed in a rear portion of the cover 26, and the arrangement recess 26A is opened to the left side, the upper side, the front side, and the rear side. A part of the bottom wall (right wall) of the arrangement recess 26A is opened, the distal end portion of the shaft 20 and the distal end portion of the connecting bracket 22 are disposed in the arrangement recess 26A, and the upper wall of the bracket 24 is exposed.

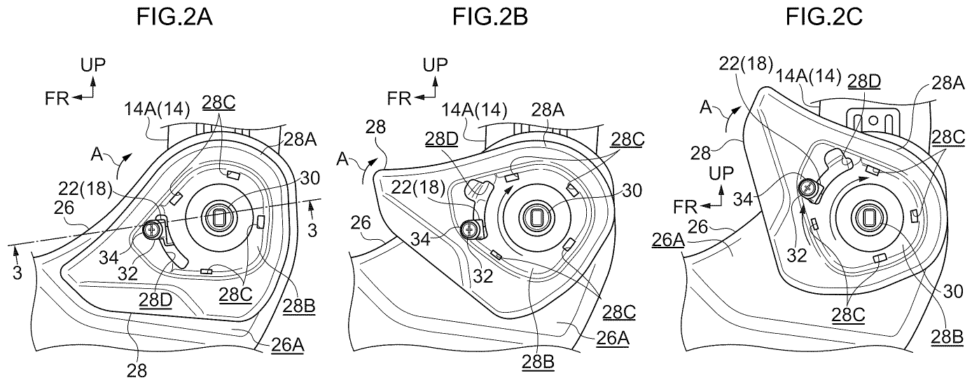

In the arrangement recess 26A, a knob 28 (see FIG. 2A) having a substantially trapezoidal plate shape and made of a resin as an operation member is disposed, and a front portion of the knob 28 protrudes forward. A tubular peripheral wall 28A is integrally provided on the entire circumference of the knob 28, and the peripheral wall 28A protrudes rightward. A coupling recess 28B having a substantially trapezoidal shape in front view is formed in the knob 28, and the coupling recess 28B is opened to the left side. A rectangular coupling hole 28C as a coupled portion is formed to penetrate through an upper portion, a lower portion, a front portion, and a rear portion of a peripheral portion of the coupling recess 28B.

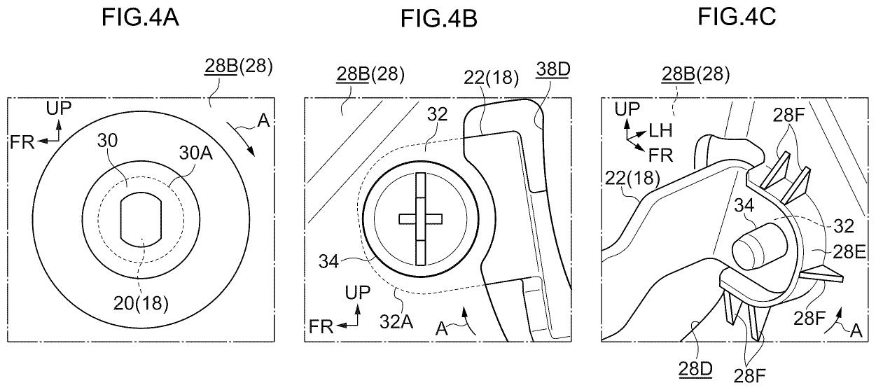

A first connecting portion 30 (see FIG. 4A) having a circular shape in front view as a connecting portion is formed at a central portion of a bottom wall (right wall) of the coupling recess 28B, and the central portion of the first connecting portion 30 is coaxially fixed (connected) to the distal end portion of the shaft 20. A first fragile portion 30A as a fragile portion is formed on the left surface of the bottom wall of the coupling recess 28B over the entire circumference of the first connecting portion 30, and a first groove having a triangular cross section is formed on the left surface of the first fragile portion 30A. Therefore, in the first fragile portion 30A, the thickness of the bottom wall of the coupling recess 28B is reduced by the first groove, and the strength of the first fragile portion 30A is reduced.

An allowance hole 28D having an elongated rectangular shape as an allowance portion is formed to penetrate through the front portion of the bottom wall of the coupling recess 28B, and the allowance hole 28D extends in the rotation direction of the shaft 20.

A second connecting portion 32 (see FIGS. 4B and 4C) having a rectangular shape in front view as a connecting portion is formed on the bottom wall of the coupling recess 28B on the front side of the upper portion of the allowance hole 28D, and the right side of the second connecting portion 32 is fixed (connected) to the distal end portion of the connecting bracket 22 by a connecting screw 34. A second fragile portion 32A as a fragile portion is formed on the left surface of the bottom wall of the coupling recess 28B over the entire periphery of the second connecting portion 32 except for the portion of the allowance hole 28D, and a second groove having a triangular cross section is formed on the left surface of the second fragile portion 32A along the outer periphery of the distal end portion of the connecting bracket 22. Therefore, in the second fragile portion 32A, the thickness of the bottom wall of the coupling recess 28B is reduced by the second groove, and the strength of the second fragile portion 32A is reduced.

A reinforcement wall 28E having a U-shaped cross section plate shape as a reinforcement portion is integrally provided around the distal end portion of the connecting bracket 22 on the right surface of the bottom wall of the coupling recess 28B, the reinforcement wall 28E protrudes rightward to reinforce the bottom wall of the coupling recess 28B, and the distal end portion of the connecting bracket 22 is substantially fitted inside. A predetermined number (five in this embodiment) of reinforcing ribs 28F having a triangular plate shape as reinforcement portions are integrally provided around the reinforcement wall 28E on the right surface of the bottom wall of the coupling recess 28B, and the reinforcing ribs 28F integrally connect the bottom wall of the coupling recess 28B and the reinforcement wall 28E to reinforce the bottom wall of the coupling recess 28B and the reinforcement wall 28E.

As described above, the first connecting portion 30 is connected to the shaft 20, the second connecting portion 32 is connected to the connecting bracket 22, the knob 28 is integrally rotatably connected to the shaft 20 and the connecting bracket 22, and the knob 28 is operated to rotate by a predetermined angle in the release direction A by the occupant, so that the shaft 20 and the connecting bracket 22 of the lock mechanism 18 are rotated by a predetermined angle in the release direction A, and the lock mechanism 18 unlocks the tilting of the seat back 14.

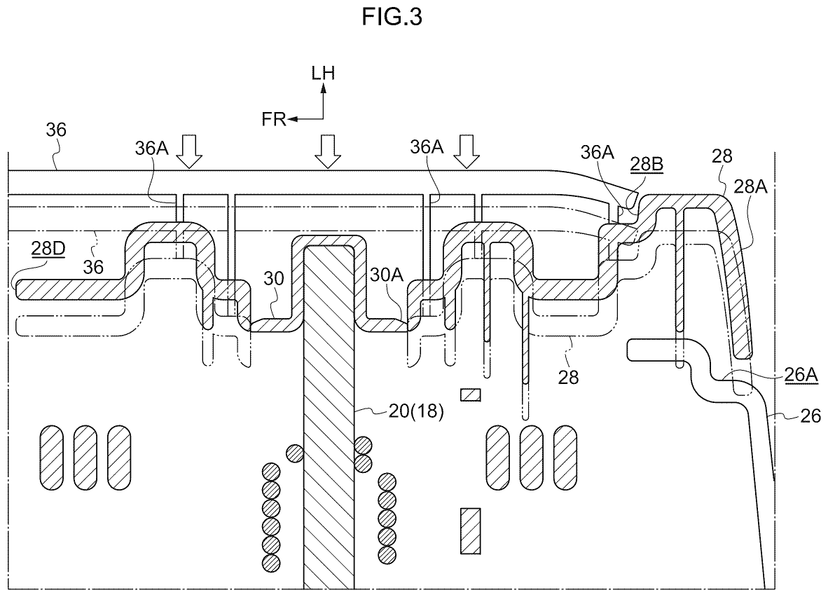

A cap 36 (see FIG. 3) having a substantially trapezoidal plate shape and made of a resin as a covering member is fitted to the coupling recess 28B, and the cap 36 is curved in a convex shape to the left side and protrudes to the left side (outside) from the left surface (outer periphery) of the knob 28. A predetermined number (three in this embodiment) of pressing cylinders 36A having a tubular shape (for example, a cylindrical shape) as pressing portions are integrally provided on the right surface of the cap 36, and the predetermined number of pressing cylinders 36A have different diameters from each other and are disposed coaxially with the shaft 20. The pressing cylinder 36A protrudes rightward, and the pressing cylinder 36A abuts on the bottom wall of the coupling recess 28B on the radially outer side of the first fragile portion 30A.

A coupling claw 38 having a substantially rectangular plate shape as a coupling portion is integrally provided at an upper portion, a lower portion, a front portion, and a rear portion of the peripheral portion of the cap 36, and the coupling claw 38 extends rightward. A coupling protrusion 38A having a triangular prism shape is integrally provided at a distal end portion (right end portion) of the coupling claw 38, and the coupling protrusion 38A protrudes to the outer peripheral side of the coupling recess 28B and has a left surface disposed perpendicular to the right-left direction. The coupling claw 38 is inserted into the coupling hole 28C on a peripheral portion of the coupling recess 28B by temporary elastic deformation, and the coupling protrusion 38A is locked from the right side to the periphery of the coupling hole 28C on the peripheral portion of the coupling recess 28B, so that the leftward movement of the coupling protrusion 38A is locked, and the leftward movement of the cap 36 is locked, whereby the cap 36 is integrally rotatably connected to the knob 28.

Next, the operation of this embodiment will be described.

In the reclining device 16 of the vehicle seat 10 having the above configuration, the lock mechanism 18 locks the tilting of the seat back 14. The first connecting portion 30 of the knob 28 is connected to the shaft 20 of the lock mechanism 18, the second connecting portion 32 of the knob 28 is connected to the connecting bracket 22 of the lock mechanism 18, and the knob 28 is integrally rotatably connected to the shaft 20 and the connecting bracket 22. In a case in which the knob 28 (including the cap 36) is operated to rotate by a predetermined angle in the release direction A, the shaft 20 and the connecting bracket 22 are rotated by a predetermined angle in the release direction A integrally with the knob 28, and the lock mechanism 18 unlocks the tilting of the seat back 14.

In a case in which an impact load from the B-pillar of the vehicle is input to the cap 36 at the time of side collision of the vehicle and the cap 36 is moved rightward (inward in the vehicle width direction), the pressing cylinder 36A of the cap 36 presses the bottom wall of the coupling recess 28B of the knob 28, and the knob 28 is moved rightward, so that the bottom wall of the coupling recess 28B is broken (crushed) at the first fragile portion 30A around the first connecting portion 30 and the second fragile portion 32A around the second connecting portion 32, and the knob 28 is disconnected from the shaft 20 and the connecting bracket 22 (see a two-dot chain line in FIG. 3). Therefore, even in a case in which the knob 28 is operated to rotate by an impact load, the rotation of the shaft 20 and the connecting bracket 22 can be suppressed, so that the unlocking of the tilting of the seat back 14 can be suppressed and the unnecessary tilting of the seat back 14 can be suppressed.

The cap 36 protrudes to the left side of the left surface of the knob 28 (see a solid line in FIG. 3). Therefore, at the time of side collision of the vehicle, an impact load can be input to the cap 36 before the knob 28, and the knob 28 can be disconnected from the shaft 20 and the connecting bracket 22 by pressing of the knob 28 by the cap 36 (pressing cylinder 36A).

At the time of side collision of a vehicle, the knob 28 is broken starting from the first fragile portion 30A and the second fragile portion 32A. Therefore, the knob 28 can be appropriately broken.

The first connecting portion 30 and the second connecting portion 32 of the knob 28 are connected to the shaft 20 and the connecting bracket 22, respectively, and in a case in which the knob 28 is broken, the first connecting portion 30 and the second connecting portion 32 are disconnected from the shaft 20 and the connecting bracket 22, respectively. Therefore, the first connecting portion 30 and the second connecting portion 32 are connected to the shaft 20 and the connecting bracket 22, respectively, whereby the connection strength of the knob 28 with the shaft 20 and the connecting bracket 22 can be increased, and the shaft 20 and the connecting bracket 22 can be appropriately rotated by the rotation of the knob 28.

At the time of side collision of the vehicle, the vicinity of the distal end portion of the connecting bracket 22 is inserted into the allowance hole 28D of the knob 28. Therefore, even in a case in which the knob 28 is operated to rotate in the release direction A by an impact load, the knob 28 is rotated by a predetermined angle, and the rotation of the knob 28 is allowed (the knob 28 is not communicated with the connecting bracket 22) until the lower end of the allowance hole 28D abuts on the vicinity of the distal end portion of the connecting bracket 22 (see FIG. 2B). Thereby, unlocking of tilting of the seat back 14 can be appropriately suppressed.

After the side collision of the vehicle (after the knob 28 is disconnected from the shaft 20 and the connecting bracket 22), the knob 28 is operated to rotate by a predetermined angle in the release direction A, and the lower end of the allowance hole 28D abuts on the vicinity of the distal end portion of the connecting bracket 22, so that the knob 28 is communicated with the connecting bracket 22 (see FIG. 2B). Therefore, in a case in which the knob 28 is further operated to rotate by a predetermined angle in the release direction A (see FIG. 2C), the connecting bracket 22 can be rotated by a predetermined angle in the release direction A, and the tilting of the seat back 14 can be unlocked. Thereby, the seat back 14 can be tilted, and the occupant can escape to the outside of the vehicle, for example.

In this embodiment, the knob 28 is provided with two connecting portions (the first connecting portion 30 and the second connecting portion 32). However, the knob 28 may be provided with one or three or more connecting portions.

In this embodiment, the knob 28 is provided with the reinforcing ribs 28F. However, the knob 28 is not necessarily provided with the reinforcing ribs 28F.

In this embodiment, the knob 28 is not communicated with the connecting bracket 22 until the knob 28 is operated to rotate by a predetermined angle in the release direction A after the knob 28 is disconnected from the shaft 20 and the connecting bracket 22. However, the knob 28 is not necessarily communicated with the connecting bracket 22 until the knob 28 is operated to rotate by less than a predetermined angle or more than a predetermined angle in the release direction A after the knob 28 is disconnected from the shaft 20 and the connecting bracket 22.

### Second Embodiment

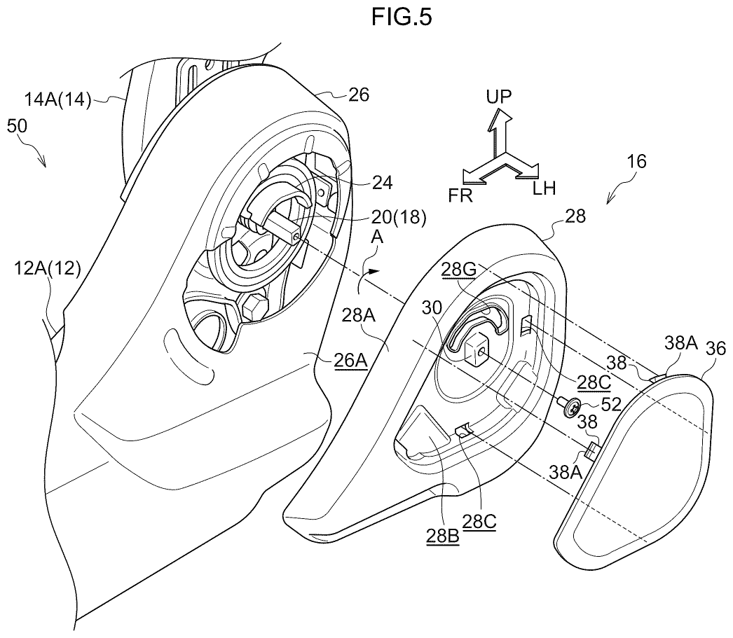

FIG. 5 is an exploded perspective view illustrating a vehicle seat 50 according to a second embodiment of the invention as viewed from a diagonally front left side.

The vehicle seat 50 according to this embodiment has substantially the same configuration as that of the first embodiment, but differs in the following points.

As illustrated in FIG. 5, in the reclining device 16 of the vehicle seat 50, the connecting bracket 22 is not provided in the lock mechanism 18.

An upper wall (restriction portion) of the bracket 24 (restriction member) extends leftward, and the upper wall of the bracket 24 protrudes to the arrangement recess 26A of the cover 26.

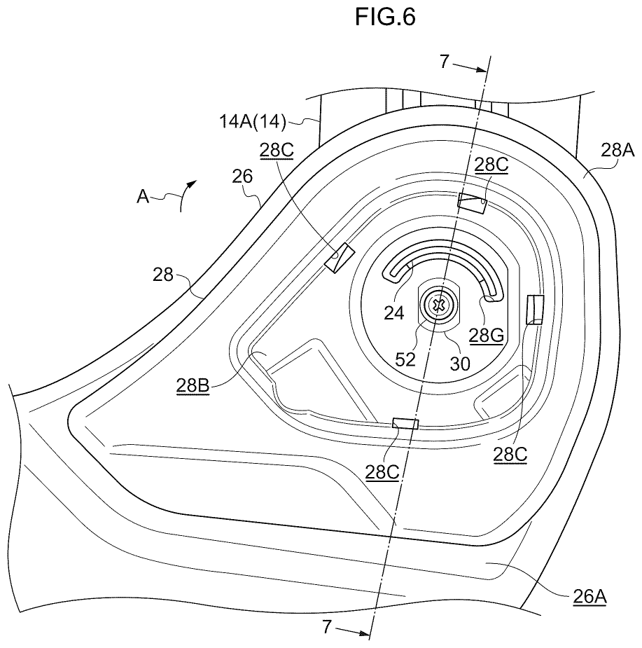

In the bottom wall of the coupling recess 28B of the knob 28 (see two-dot chain lines in FIGS. 6 and 7 and FIGS. 8A and 8B), the central portion of the first connecting portion 30 is coaxially fixed (connected) to the distal end portion of the shaft 20 by a screw 52. An elongated restriction hole 28G as a restricted portion is formed to penetrate through the bottom wall of the coupling recess 28B on the upper side of the first connecting portion 30, and the restriction hole 28G extends in the front-rear direction and is curved in an extending direction to protrude upward. The knob 28 is not provided with the allowance hole 28D, the second connecting portion 32, the second fragile portion 32A (second groove), the connecting screw 34, the reinforcement wall 28E, and the reinforcing ribs 28F.

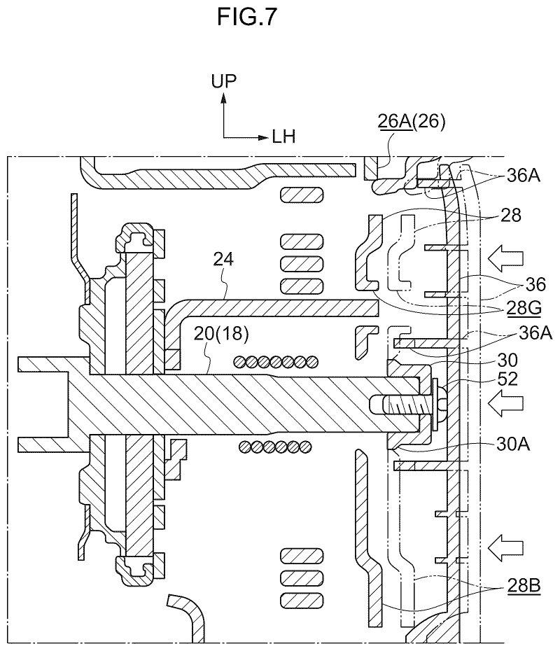

A predetermined number (two in this embodiment) of pressing cylinders 36A are provided in the cap 36 (see a two-dot chain line in FIG. 7), and the pressing cylinders 36A are opposed to the bottom wall of the coupling recess 28B on the radially outer side of the first fragile portion 30A.

Next, the operation of this embodiment will be described.

In the reclining device 16 of the vehicle seat 50 having the above configuration, the lock mechanism 18 locks the tilting of the seat back 14. The first connecting portion 30 of the knob 28 is connected to the shaft 20 of the lock mechanism 18, and the knob 28 is integrally rotatably connected to the shaft 20. In a case in which the knob 28 (including the cap 36) is operated to rotate by a predetermined angle in the release direction A, the shaft 20 is rotated by a predetermined angle in the release direction A integrally with the knob 28, and the lock mechanism 18 unlocks the tilting of the seat back 14.

In a case in which an impact load from the B-pillar of the vehicle is input to the cap 36 at the time of side collision of the vehicle and the cap 36 is moved rightward (inward in the vehicle width direction), the pressing cylinder 36A of the cap 36 presses the bottom wall of the coupling recess 28B of the knob 28, and the knob 28 is moved rightward, so that the bottom wall of the coupling recess 28B is broken (crushed) at the first fragile portion 30A around the first connecting portion 30, and the knob 28 is disconnected from the shaft 20 (see a solid line in FIG. 7). Therefore, even in a case in which the knob 28 is operated to rotate by an impact load, the rotation of the shaft 20 can be suppressed, so that the unlocking of the tilting of the seat back 14 can be suppressed and the unnecessary tilting of the seat back 14 can be suppressed.

In a case in which the knob 28 is disconnected from the shaft 20, the upper wall of the bracket 24 is inserted into the restriction hole 28G of the knob 28 to restrict the rotation of the knob 28. Therefore, the rotation of the shaft 20 can be restricted, and the unlocking of the tilting of the seat back 14 can be restricted.

The cap 36 protrudes to the left side of the left surface of the knob 28 (see a two-dot chain line in FIG. 7). Therefore, at the time of side collision of the vehicle, an impact load can be input to the cap 36 before the knob 28, and the knob 28 can be disconnected from the shaft 20 by pressing of the knob 28 by the cap 36 (pressing cylinder 36A).

At the time of side collision of a vehicle, the knob 28 is broken starting from the first fragile portion 30A. Therefore, the knob 28 can be appropriately broken.

What is claimed is:

1. A reclining device comprising:
a lock mechanism locking tilting of a seat back in a vehicle seat;
a connecting member provided at the lock mechanism, the connecting member being rotated so that the lock mechanism unlocks tilting of the seat back; and
an operation member connected to the connecting member, the operation member being operated to rotate the connecting member and being disconnected from the connecting member by receiving an impact load at a time of a side collision of a vehicle.

2. The reclining device according to claim 1, comprising a covering member covering the operation member and disconnecting the operation member from the connecting member by receiving an impact load at the time of a side collision of the vehicle to press the operation member.

3. The reclining device according to claim 2, wherein the covering member is disposed outside an outer periphery of the operation member.

4. The reclining device according to claim 1, wherein the operation member is broken by an impact load to be disconnected from the connecting member.

5. The reclining device according to claim 4, comprising a fragile portion provided at the operation member and serving as a starting point of breakage of the operation member.

6. The reclining device according to claim 4, comprising a plurality of connecting portions provided at the operation member, each of the connecting portions being connected to the connecting member, and each of the connecting portions being disconnected from the connecting member due to the operation member being broken.

7. The reclining device according to claim 1, wherein the operation member is operated by a predetermined amount to cause the lock mechanism to unlock tilting of the seat back, and the operation member is operated by the predetermined amount or more to be connected to the connecting member after the operation member has been disconnected from the connecting member.

8. The reclining device according to claim 7, comprising an allowance portion provided at the operation member, the operation member being allowed to be operated by the predetermined amount or more by the allowance portion so that the operation member is connected to the connecting member after the operation member has been disconnected from the connecting member.

9. The reclining device according to claim 1, wherein the operation of the operation member is restricted in a case in which the operation member is broken by an impact load to be disconnected from the connecting member.

10. A vehicle seat comprising:
a seat cushion;
a seat back; and
the reclining device according to claim 1 provided between the seat cushion and the seat back.
